(19) United States
(12) Patent Application Publication
(10) Pub. No.: US 2017/0115726 A1
(43) Pub. Date: Apr. 27, 2017

(54) INCORPORATING BIOMETRIC DATA FROM MULTIPLE SOURCES TO AUGMENT REAL-TIME ELECTRONIC INTERACTION

(71) Applicant: Blue Goji Corp., Austin, TX (US)

(72) Inventor: Coleman Fung, Spicewood, TX (US)

(21) Appl. No.: 14/920,831

(22) Filed: Oct. 22, 2015

(51) Int. Cl. G06F 3/01; A63F 13/20; G06K 9/00

(52) U.S. Cl. CPC G06F 3/011; G06K 9/00892; A63F 13/20

(57) ABSTRACT

A system for incorporating biometric data from multiple sources to augment real-time electronic interaction, comprising a biometric data collector that receives input from a plurality of devices including visual information from a camera, analyzes at least a portion of the input, derives a plurality of biometric data values based at least in part on the analysis, and presents at least a portion of the plurality of biometric data values as output.

### CROSS-REFERENCE TO RELATED APPLICATIONS

None.

### BACKGROUND OF THE INVENTION

Field of the Art

The disclosure relates to the field of electronic entertainment, and more particularly to the field of using biometric data in electronic games.

Discussion of the State of the Art

In the art of electronic gaming, users interact with games and applications using a variety of input and feedback devices, such as keyboards and video game controllers. Generally, interaction is manual and users manipulate a variety of buttons, switches, control sticks, and other control elements to provide input. However, a variety of games and applications are fitness and health-oriented, encouraging users to exercise and train during use and may incorporate biometric data pertaining to a user as a part of interaction or gameplay. For such uses, there are some alternate input devices for collecting or measuring biometric data, such as a user's body posture or weight distribution, or biometric sensors that may be worn on the body such as rings or armbands. However, a wealth of biometric information may be obtained without the need for specialized devices or controllers, using camera-derived information, allowing users to interact using biometric data for various applications and games without having to purchase or configure additional devices and without the potential discomfort of having to wear additional hardware.

What is needed, is a means to incorporate a wide range of real-time biometric data to augment interaction with electronic software applications, including those that may derive user biometric information using currently-available or specially-designed camera devices to enhance interaction.

### SUMMARY OF THE INVENTION

Accordingly, the inventor has conceived and reduced to practice, in a preferred embodiment of the invention, a system and method for incorporating biometric data from multiple sources to augment real-time electronic interaction, including embodiments that use a camera device to determine a variety of biometric information pertaining to a user and provide that information for use as input in a software application.

According to a preferred embodiment of the invention, a system for incorporating biometric data from multiple sources to augment real-time electronic interaction, comprising a biometric data collector comprising at least a plurality of programming instructions stored in a memory and operating on a processor of a computing device and configured to receive at least a plurality of electronic data input, and configured to analyze at least a portion of the plurality of input, and configured to produce at least a plurality of biometric data values based at least in part on the analysis, and configured to provide at least a portion of the biometric data values as electronic data output, is disclosed.

In another preferred embodiment of the invention, a method for incorporating biometric data from multiple sources to augment real-time electronic interaction, comprising the steps of receiving, at a biometric data collector comprising at least a plurality of programming instructions stored in a memory and operating on a processor of a computing device and configured to receive at least a plurality of electronic data input, and configured to analyze at least a portion of the plurality of input, and configured to produce at least a plurality of biometric data values based at least in part on the analysis, and configured to provide at least a portion of the biometric data values as electronic data output, a plurality of electronic data input; analyzing, at the biometric data collector, at least a portion of the received electronic data input; deriving a plurality of biometric data values based at least in part on at least a portion of the analysis; and providing at least a portion of the derived biometric data values as output data, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for unifying biometric data from multiple sources and using a camera to derive user biometric data, according to a preferred embodiment of the invention.

FIG. 6 is a flow diagram illustrating an exemplary method for using a camera to derive user biometric data, according to a preferred embodiment of the invention.

FIG. 7 is a block diagram of an alternative arrangement of an exemplary system architecture, illustrating the use of multiple camera devices.

FIG. 8 is a block diagram of an alternative arrangement of an exemplary system architecture, illustrating the use of a cloud-based biometric platform.

### DETAILED DESCRIPTION

The inventor has conceived and reduced to practice, in a preferred embodiment of the invention, a system and method for incorporating biometric data from multiple sources to augment real-time electronic interaction that uses a camera device to determine a variety of biometric information pertaining to a user and provide that information for use as input in a software application.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

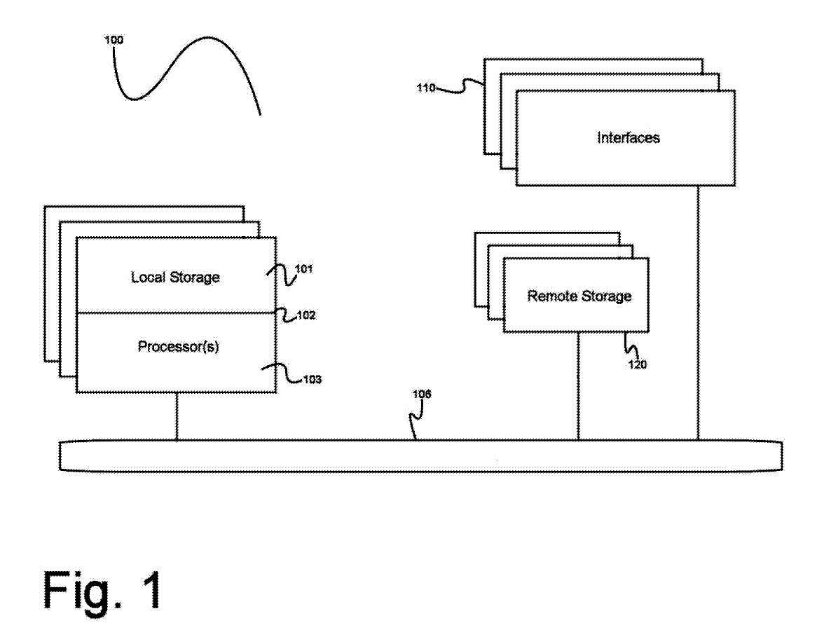

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

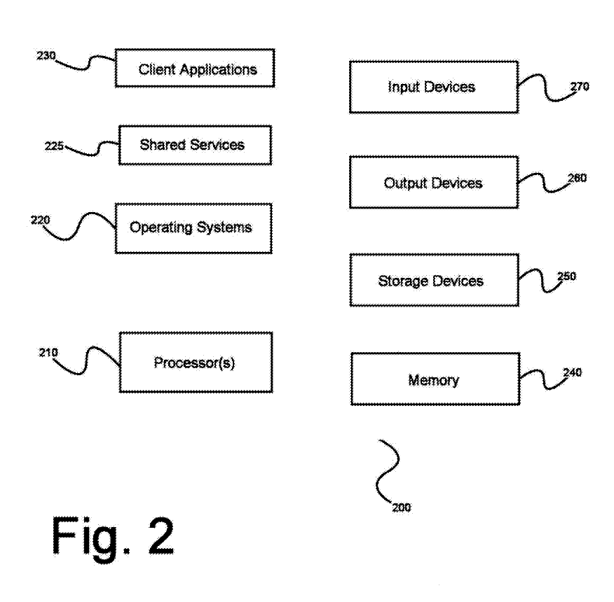

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

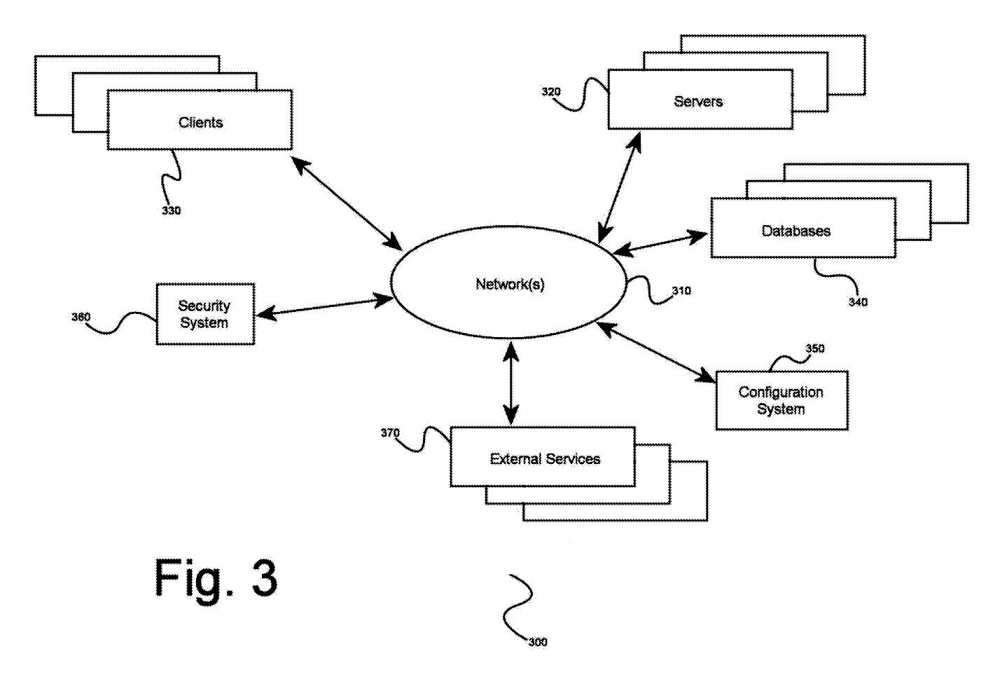

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

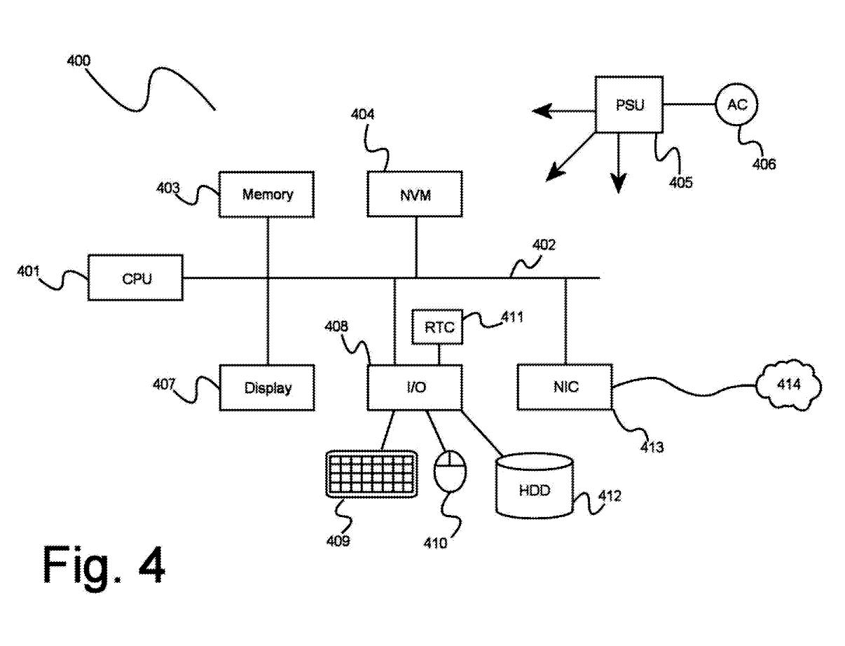

FIG. 4 shows an exemplary overview of a computer system 400 as may be used in any of the various locations throughout the system. It is exemplary of any computer that may execute code to process data. Various modifications and changes may be made to computer system 400 without departing from the broader scope of the system and method disclosed herein. Central processor unit (CPU) 401 is connected to bus 402, to which bus is also connected memory 403, nonvolatile memory 404, display 407, input/output (I/O) unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to a main alternating current (AC) supply 406. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

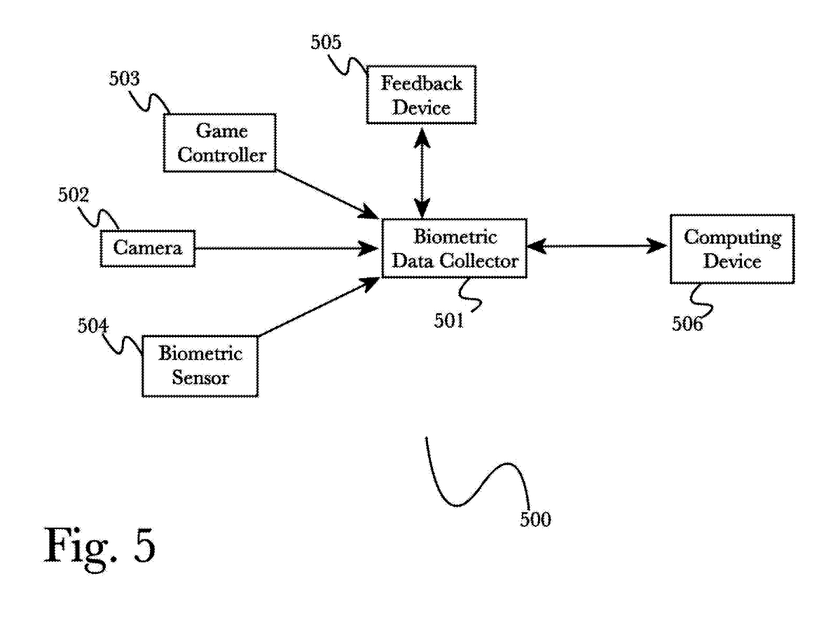

FIG. 5 is a block diagram of an exemplary system architecture 500 for incorporating biometric data from multiple sources to augment real-time electronic interaction, according to a preferred embodiment of the invention. According to the embodiment, a biometric data collector 501 may be used to receive a plurality of electronic input data from a variety of sources, and may derive a plurality of biometric data values from received input and provide at least a portion of the biometric data values (optionally, along with at least a portion of the original received input data) to a computing device 506 such as, for example, a personal computer or a video gaming console. Exemplary input data sources may include (but are not limited to) biometric sensor 504 that may be any hardware sensor device configured to collect biometric information pertaining to a human user (for example, a wearable fitness tracker or similar biometric sensing device, such as FITBIT™, MICROSOFT BAND™ or APPLE WATCH™), game controller 503 that may be any hardware input device configured for interaction with electronic games, camera 502 that may be any photographic or video capture device, or feedback device 505 that may be any hardware-based user feedback device, such as a vibration motor or other haptic feedback device.

According to the embodiment, biometric data collector 501 may analyze received input data from camera 502 and optionally any additional sources, and may unify received data from multiple sources to produce a plurality of biometric data values based at least in part on the analysis results, and may then provide this unified biometric data to a computing device 506 as a singular electronic data input (that is, computing device 506 may receive the plurality of biometric data values as if they were being provided by a single device, and any combination or separation of biometric data to or from multiple sources or devices is handled by biometric data collector 501). For example, received image data from camera 502 may be processed to derive biometric data based on a user's skin tone, observable exertion indicators such as sweat, pupil dilation, or other visually-observable biometric indicators. Produced biometric data values may be configured to be used as input by computing device 506, for example by receiving configuration information from computing device 506 according to a currently-running software application or according to hardware capabilities or user preference. For example, a video gaming console may send configuration information instructing biometric data collector 501 on proper data types or formatting, based on a particular game currently being played or peripheral devices in use. Biometric data values may be used to drive operation of a computing device 506 in a variety of ways according to the nature of computing device 506 or a software application operating thereon. For example, biometric data may be used to directly modify presented audio or video content, such as an onscreen indication of biometric data or an audio tone corresponding to biometric values. As another example, computing device 506 may be a video gaming device that receives biometric data and utilizes it as a component of user input within a particular game, for example to modify background music based on a user's mood or to react to a user's stress or exertion data. For example, according to an embodiment of the invention, a meditation app is provided where a user's breathing rate is measured, either using a camera or directly using for example an accelerometer. According to the embodiment, the breathing rate may be used informationally—tracked and reported back and used for other purposes. Additionally, it may be used to drive interactive activity such as gameplay or music selection. According to another embodiment, an exercise game may be provided where the intensity of the game varies based upon a user's breathing rate or heart rate. When the user reaches a target heart or breathing rate, the intensity may automatically drop off or level off. That is, if a user is slacking off in intensity, then the game will encourage the user to speed things up.

According to the embodiment, camera 502 may be configured to collect image information during user activity and provide at least a portion of this information for use as input data by biometric data collector 501, for example by taking still images or by recording live video of a user interacting with a computing device 506. For example, a user playing an electronic game on a video gaming console may be recorded as they play, or still images may be captured at intervals, and these captured image data may be sent to biometric data collector 501 and used to produce a plurality of biometric data values, which may then be provided to the video gaming console for use as input to enhance game interaction. In an alternative arrangement, produced biometric data values may be provided to a computing device 506 that a user is not currently interacting with, for example to collect biometric data values pertaining to a user on a computing device 506 while the user is performing other tasks or interacting with a separate device (such an arrangement may be useful, for example, to collect user biometric data while they play a video game that is not configured to accept biometric input). Additionally, camera 502 may be any of a wide variety of camera devices known in the art, such as (for example) a webcam operating on a user's device (for example, a personal computer or mobile phone with an integral or removable camera), or a peripheral camera connected to a computing device 506 via a network or wired connection, such as KINECT™. According to the hardware capabilities of camera 502, image data may be captured in multiple frequency bands (such as infrared, for example) or with additional processing applied to enhance the data (such as cropping and color-enhancing, for example). Use of additional visual frequency bands or image enhancements may enhance information sent to biometric data collector 501 for use in producing biometric data values, for example by using infrared imagery to monitor a user's skin for flushing.

According to the embodiment, biometric data collector 501 may optionally provide feedback using a feedback device 505, for example a vibration motor or other haptic feedback device. Feedback may be directed by computing device 506, for example vibration corresponding to events occurring in a software application such as a video game, or feedback may be directed by biometric data collector 501 to provide user feedback in addition to or in place of any feedback that may be provided or directed by computing device 506. Additionally, in a manner similar to the unification of biometric data from multiple sources as described above, biometric data collector 501 may receive feedback data from a computing device 506 and may divide feedback data and send portions thereof to individual connected devices. For example, a portion of feedback data may be sent to a user's device to direct a vibration motor, while another portion of different feedback data may be sent to a second user's device, so that each user receives individualized feedback. Such operation may be used to add user feedback capabilities in arrangement that otherwise may not provide them, such as to add vibration feedback to non-gaming software applications. In this manner, feedback may be directed by biometric data collector 501 and may be based at least in part on received input data or derived biometric data values, such that a user may receive immediate feedback on their current biometric information. For example, a user may receive immediate feedback based on their posture as determined by biometric data collector 501 based on captured image information from camera 502, as may be particularly useful in health-related arrangements such as for physical therapy or ergonomic correction, where a user may correct or optimize their own biometric state through the use of feedback, without needing an observer or coach to assist them. Another exemplary use case may be the utilization of negative feedback, such as activating a feedback device 505 to notify a user if their biometric values exceed a threshold (for example, activating a vibration motor to notify a user that their posture requires correction, or to wake a user that may be falling asleep).

### Detailed Description of Exemplary Embodiments

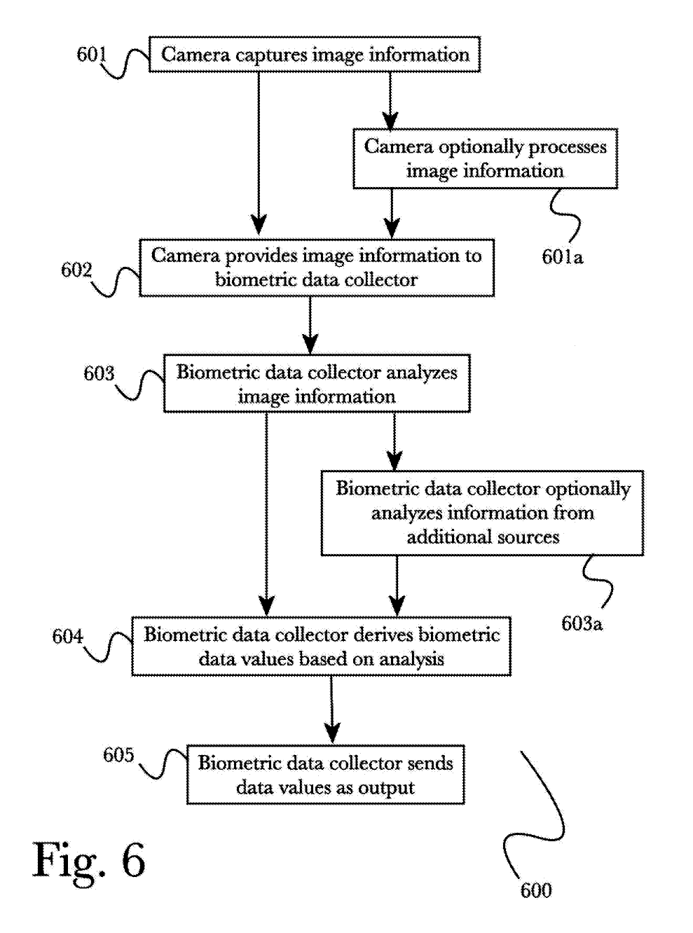

FIG. 6 is a flow diagram illustrating an exemplary method 600 for incorporating biometric data from multiple sources to augment real-time electronic interaction, according to a preferred embodiment of the invention. In an initial step 601, a camera may capture a plurality of image information such as by recording video or a plurality of still images. In an optional substep 601a, the camera may perform process some or all of the plurality of image information, according to its capabilities or configuration (for example, applying filters to enhance an image by altering color balance or reducing visual noise). In a next step 602, the camera may provide a plurality of image information to a biometric data collector for use in deriving biometric data. In a next step 603, the biometric data collector may analyze at least a portion of the received image information, and in an optional substep 603a may analyze received information from additional sources such as biometric sensors or other devices that may provide information for use in deriving biometric data. In a next step 604, the biometric data collector may derive a plurality of biometric data values based at least in part on analysis performed on receive information, and in a final step 605 may output biometric data values for use or review.

For example, a user may be playing a video game on a home gaming console such as XBOX™ or PLAYSTATION™. During gameplay, a camera (for example, such as KINECT™) may record video of the user during their interaction with the game, and send the video to a biometric data collector. The video may be analyzed and used to produce a plurality of data values, for example the user's current exertion as may be derived from observable indicators (such as pupil dilation, skin flushing, or sweat density). This biometric data may then be provided to the gaming console for use as game input, for example sending the user's exertion level to the console for use in a fitness or simulation game.

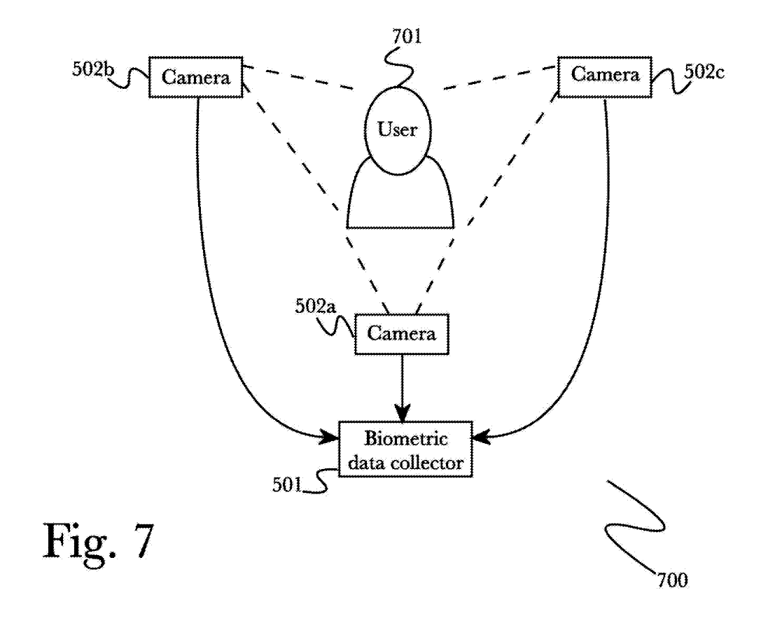

FIG. 7 is a block diagram of an alternative arrangement of an exemplary system architecture 700, illustrating the use of multiple camera devices. As described previously (referring to FIG. 5), a biometric data collector 501 may receive input information from multiple sources for use in deriving biometric data values. According to the embodiment, such sources may comprise multiple cameras 502a-c, that may be arranged to capture imagery of a user 701 from different perspectives. For example, as illustrated, cameras 502a-c may be arranged about a user within a room, to capture imagery of user 701 from different angles. This imagery may then be utilized by biometric data collector 501 to derive more detailed biometric data, for example using multiple camera angles to produce a precise description of a user's posture. One exemplary use of such an arrangement may be for interaction with a video game or software application simulating a yoga class or similar exercise simulation, wherein a user's posture may be used as input to determine their performance. Another example might be using multiple cameras to capture imagery using different filters, such as using one camera 502a to capture eye position or movement, a second camera 502b to capture infrared, and a third camera 502c to capture visible light (as with a traditional camera for photography). These different imagery “channels” may then be used to derive more complex or detailed biometric data values, such as using infrared imagery to derive various indicators of stress or physical exertion, or eye movement to determine more abstract biometric information such as whether a user is being honest or is distracted. Such an arrangement may be useful, for example, in various types of video games such as during interaction with an onscreen virtual character, where a user's honesty or attention level might be factored into the onscreen character's responses (such as in a roleplaying game where a player may be penalized for lying to a character, or a puzzle game that penalizes a player for letting their attention wander).

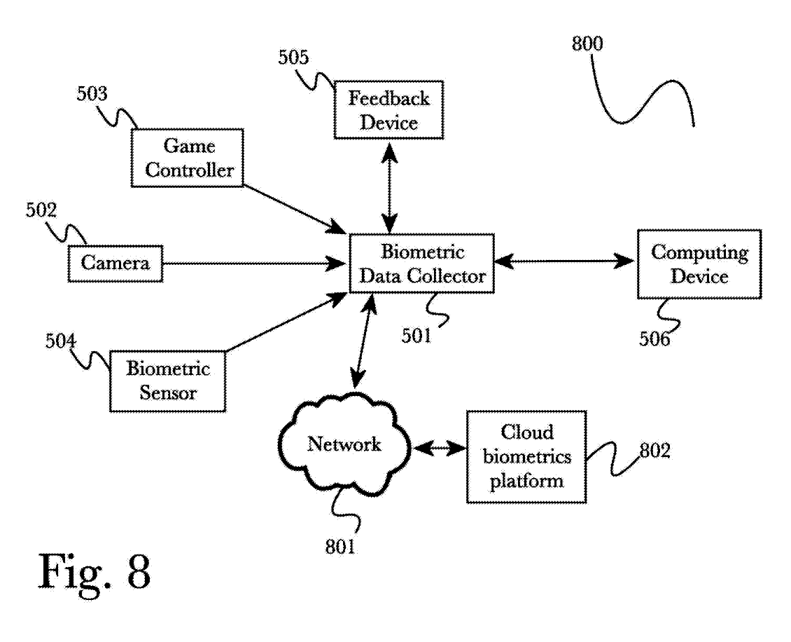

FIG. 8 is a block diagram of an alternative arrangement of an exemplary system architecture 800, illustrating the use of a cloud-based biometric platform. According to the embodiment, a biometric data collector 501 may be configured to communicate via a network 801 such as the Internet or a local-area network using a variety of communication means (for example including, but not limited to, WiFi, cellular radio communication, or BLUETOOTH™). Biometric data collector may be further configured to receive input information from, and optionally provide biometric data values to, a cloud-based biometrics platform 802 that may be an online information storage service such as DROPBOX™ or a software product or service specifically configured for storing and providing biometric data, such as Microsoft HEALTHVAULT™. In this manner, input information may be received from a biometrics platform 802 to analyze and incorporate historical information, such as a user's past biometric data. For example, a user may wish to utilize health data collected from various sources and stored in a biometrics platform 802 to effectively transfer a biometric profile across software applications, similar to a user account that may be used to identify a user or restore information such as game progress or performance scores. For example, if a user is beginning a new game that is configured to use biometric information (for example, an exercise game that adjusts its difficulty or the types of exercise according to a user's ability as determined using biometric data values), they may import existing information from a biometrics platform 802 to set an initial configuration within the application based on their previously-collected biometrics. Biometric data collector 501 may also provide biometric data values to a biometrics platform 802 for storage, so that any new biometric data that is derived may be incorporated into a user's persistent profile or information storage, in turn enabling data values derived by biometric data collector 501 to be used at another time by retrieving from biometrics platform 802, for example for review in a software application such as APPLE HEALTH™. Such functionality may be used to expand the capabilities of a biometric data collector 501 to include data gathering for health monitoring or “quantified self” applications, in addition to immediate-use arrangement such as for interaction with software applications and games.

The skilled person will be aware of a range of possible modifications of the various embodiments described above. Accordingly, the present invention is defined by the claims and their equivalents.

What is claimed is:

1. A system for incorporating biometric data from multiple sources to augment real-time electronic interaction, comprising:
a biometric data collector comprising at least a plurality of programming instructions stored in a memory and operating on a processor of a computing device and configured to receive at least a plurality of electronic data input, and configured to analyze at least a portion of the plurality of input, and configured to produce at least a plurality of biometric data values based at least in part on the analysis, and configured to provide at least a portion of the biometric data values as electronic data output.

2. The system of claim 1, further comprising a plurality of biometric hardware sensors configured to provide a plurality of biometric data to at least a biometric data collector.

3. The system of claim 2, wherein at least a portion of the plurality of biometric hardware sensors are wearable electronic devices.

4. The system of claim 1, further comprising a camera, the camera comprising at least a photographic sensor operating on a computing device and configured to capture at least a plurality of visual information and configured to provide at least a portion of the capture visual information to a biometric data collector.

5. The system of claim 4, wherein the camera is configured to collect optical data using a plurality of frequency bands.

6. The system of claim 5, wherein the plurality of electronic data input comprises at least a portion of the optical data.

7. The system of claim 6, wherein the plurality of biometric data values comprises at least a plurality of skin response data pertaining to a user's skin tone, the skin response data being based at least in part on at least a portion of the optical data.

8. The system of claim 7, wherein the skin response data comprises at least an indication of blood flow to a user's face.

9. The system of claim 1, wherein at least a portion of the plurality of electronic data input is retrieved from a data storage.

10. The system of claim 9, wherein at least a portion of the biometric data values are stored in the data storage.

11. The system of claim 1, wherein at least a portion of the electronic data output is received by a computing device.

12. The system of claim 11, wherein the computing device directs the operation of a video display based at least in part on at least a portion of the received electronic data output.

13. The system of claim 11, wherein the computing device modified a plurality of stored data values in a data storage based at least in part on at least a portion of the received electronic data output.

14. A method for incorporating biometric data from multiple sources to augment real-time electronic interaction, comprising the steps of:
receiving, at a biometric data collector comprising at least a plurality of programming instructions stored in a memory and operating on a processor of a computing device and configured to receive at least a plurality of electronic data input, and configured to analyze at least a portion of the plurality of input, and configured to produce at least a plurality of biometric data values based at least in part on the analysis, and configured to provide at least a portion of the biometric data values as electronic data output, a plurality of electronic data input;
analyzing, at the biometric data collector, at least a portion of the received electronic data input;
deriving a plurality of biometric data values based at least in part on at least a portion of the analysis; and
providing at least a portion of the derived biometric data values as output data.

15. The method of claim 14, further comprising the steps of:
capturing, at a camera comprising at least a photographic sensor operating on a computing device and configured to capture at least a plurality of visual information and configured to provide at least a portion of the capture visual information to a biometric data collector, a plurality of visual information; and
providing at least a portion of the visual information as electronic data input to a biometric data collector.

16. The method of claim 15, further comprising the step of enhancing at least a portion of the visual data.
